(19) United States
(12) Patent Application Publication
(10) Pub. No.: US 2025/0236746 A1
(43) Pub. Date: Jul. 24, 2025

(54) PRINTING INK FOR WASHING-FREE COLD TRANSFER PRINTING PROCESS

(71) Applicant: Newtech Textile Technology Development (Shanghai) Co., LTD, Shanghai (CN)

(72) Inventor: Po-Wen CHUNG, Shanghai (CN)

(21) Appl. No.: 18/700,793

(22) PCT Filed: Oct. 26, 2023
(86) PCT No.: PCT/CN2023/126790

§ 371 Date: Apr. 12, 2024

(30) Foreign Application Priority Data
May 22, 2023 (CN) 202310582499.0

(51) Int. Cl. C09D 11/102; C08G 18/08; C08G 18/12; C08G 18/42; C09D 11/03; D06P 1/16; D06P 1/52; D06P 1/642; D06P 3/54; D06P 5/28

(52) U.S. Cl. CPC C09D 11/102; C08G 18/0823; C08G 18/12; C08G 18/4277; C09D 11/03; D06P 1/16; D06P 1/5285; D06P 1/6423; D06P 3/54; D06P 5/006; D10B 2331/04

(57) ABSTRACT

A printing ink for a washing-free cold transfer printing process and a method for printing a polyester fabric by using the printing ink are provided. The printing ink includes a thickener, a disperse dye, a binder, a surfactant, a dispersant and water. The thickener is a waterborne polyurethane thickener with a solid content of about 20-40% and preferably about 25-35%, and the waterborne polyurethane thickener has the following structure:

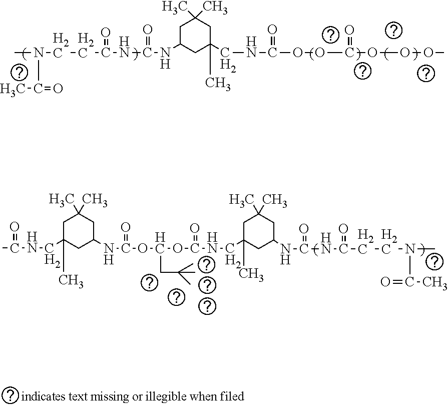

where m is 8-20, preferably 8-15, n is 15-25, preferably 17-20, and k is 1-8, preferably 2-6.

### BACKGROUND

### Technical Field

The present disclosure relates to a printing ink for a washing-free cold transfer printing process and a method for printing a polyester fabric by using the printing ink. By way of the printing ink and the printing method, a strengthened fixing effect of a disperse dye on a polyester fabric can be achieved, thereby eliminating a washing process after printing and color fixing, and thereby realizing washing-free cold transfer printing of the disperse dye.

### Related Art

Printing processes of textiles are methods for printing patterns of various colors on textiles. Common printing processes may include direct printing, discharge and resist printing and transfer printing.

The transfer printing, in a sense, is an extension of a printing technology on the textiles. However, as fabrics have uneven surfaces and countless pores, which are different from papers with high-density and flat surfaces used in the printing industry, it is difficult to obtain high-resolution patterns. Accordingly, in the printing processes of the textiles, the transfer printing includes first printing an ink containing a dye on a paper or other carriers to make a stained paper by using a printing technology, then putting a fabric under heavy pressure to make the surface of the fabric temporarily in a quasi-flat state, and transferring a pattern on the stained paper to the fabric by utilizing the migration characteristics of the dye in a certain environment. The advantages of transfer printing process are that patterns are artistic, the patterns with abundant layers and realistic forms can be printed, a processing flow is short, and a factory correspondingly has a higher processing speed after accepting orders, thereby having been developed rapidly.

Common transfer printing processes include heat transfer printing and cold transfer printing. Regarding the heat transfer printing, a dye is mainly transferred from a paper surface to a fabric by way of utilizing sublimation characteristics of the disperse dye. As the disperse dye has high affinity to polyester fibers, the heat transfer printing is mainly applied to printing of the polyester fabrics. For example, a Chinese patent CN201210055121.7 discloses a thermal sublimation waterborne intaglio printing ink and a preparation method therefor. However, the heat transfer printing process has the following problems that are difficult to solve: energy consumption is high, equipment requirements are high, other fibers that are not resistant to high temperature in polyester blended fibers are likely to be damaged, and heat transfer printing products have poor thermal migration fastness.

The cold transfer printing is mainly realized by utilizing the characteristics of a waterborne disperse dye in a wet environment, such as migration, penetration reaction crosslinking, and capillary effect. For example, a Chinese patent CN201210365576.9 discloses a disperse dye ink for cold transfer printing and an application method thereof. However, the current cold transfer printing still needs washing to remove an unfixed dye on the surface so as to improve the color fastness. Specifically, the unfixed dye refers to dye molecules that only stay on surfaces of fibers without entering the fibers and binding with the fibers. In the relevant art known to the inventor, the washing is the only way to remove the unfixed dye so as to improve the color fastness. Because under dyeing conditions, when a dye source is cut off, a single molecule dye that is adsorbed on the surfaces of fibers or even remains in a dye bath will be continuously transferred into the fibers, and a polar water environment is used as a source of a huge push force to drive the dye molecules into the non-polar fibers. The method of driving the dye into the fibers to remove the unfixed dye is simple and easy to be implemented. Therefore, the washing is a most commonly used means of removing the unfixed dye in the relevant art known to the inventor. However, a washing process is the main source of printing and dyeing wastewater. Due to strict wastewater discharge regulations implemented by China, the production capacities of printing and dyeing enterprises are limited, and the costs are increased, resulting in losing market competitiveness.

On the basis of the cold transfer printing process of the disperse dye in the prior art, the present disclosure aims to develop a printing ink for a washing-free cold transfer printing process and a method for printing a polyester fabric by using the printing ink. The printing ink and the printing method can eliminate the washing process after printing and color fixing, thereby avoiding the production of printing wastewater and thus reducing printing wastewater or even realizing zero discharge of wastewater, which have huge economic and social benefits.

### SUMMARY

In one aspect, the present disclosure provides a printing ink for a washing-free cold transfer printing process. The printing ink includes a disperse dye, a binder, a surfactant, a dispersant, a thickener and water. The thickener is a waterborne polyurethane thickener with a solid content of about 20-40% and preferably about 25-35%, and the waterborne polyurethane thickener has the following structure:

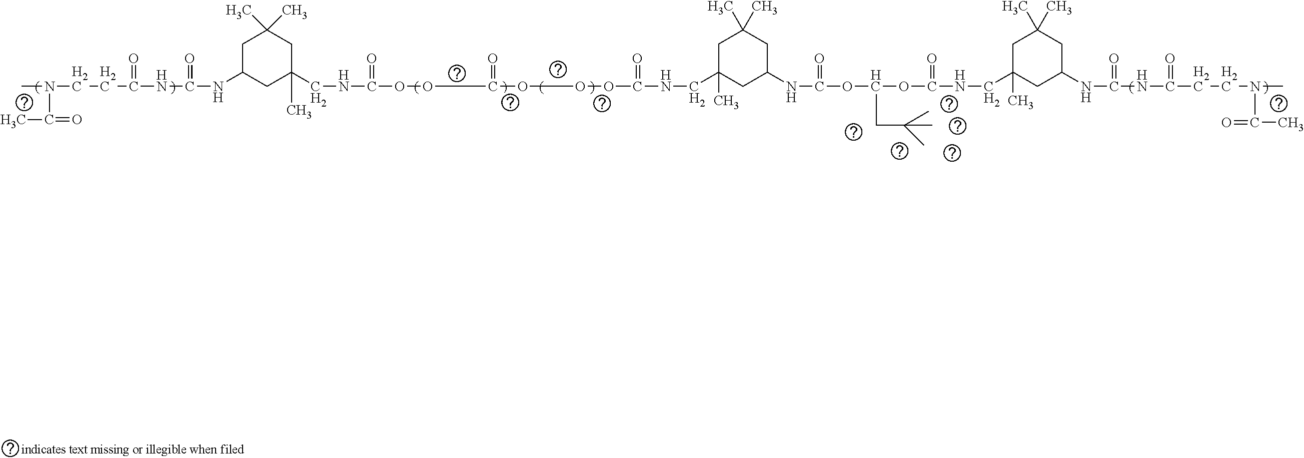

where m is 8-20, preferably 8-15, n is 15-25, preferably 17-20, and k is 1-8, preferably 2-6.

In one embodiment, for intaglio printing equipment, in the waterborne polyurethane thickener, the m is preferably 8-10, the n is preferably 17-18, and the k is preferably 3-4; for flexographic printing equipment, the m is preferably 10-13, the n is preferably 18-19, and the k is preferably 2-3; and for rotary screen printing equipment, the m is preferably 13-15, the n is preferably 19-20, and the k is preferably 5-6.

In one embodiment, the printing ink includes about 1.0-10.0% of the disperse dye, about 2.0-6.0% of the binder, about 0.5-2.0% of the surfactant, about 0.5-2.0% of the dispersant, about 3.0-15.0%, preferably about 5.0-10.0%, of the thickener and the balance of water, based on the total weight of the printing ink.

The disperse dye may be selected from disperse dyes commonly used in the printing field, including a medium temperature SE type disperse dye or a high temperature S type disperse dye. All the disperse dyes are commercially available. Examples include the medium temperature SE type disperse dye or the high temperature S type disperse dye produced by Zhejiang Longsheng Group Co., Ltd., Zhejiang Runtuo Co., Ltd., HUNTSMAN and DYESTAR.

The binder may be selected from binders commonly used in the printing field, including, for example, multifunctional aziridine binders. All the binders are commercially available. Examples include such as a 9122 binder purchased from Hangzhou Yinsheng Chemical Factory, and a TF-320 binder and an F-321A binder purchased from Zhejiang Transfar Co., Ltd.

The surfactant may be selected from surfactants commonly used in the printing field, including, for example, organosilicon surfactants. Examples include such as BYK-378 purchased from BYK Chemical, or SF-678 purchased from Shanmu Chemical Co., Ltd.

The dispersant may be selected from dispersants commonly used in the printing field, including, for example, naphthalene sulfonic acid derivative series. Examples include, for example, formaldehyde polycondensates of naphthalene sulfonic acid, such as sodium methylene bis-naphthalene sulfonate (CAS No. 36290 Apr. 7) or sodium poly [(naphthaleneformaldehyde) sulfonate] (CAS No. 9084 Jun. 4). All the dispersants are commercially available, such as an INVALONDAM dispersant (sodium poly [(naphthaleneformaldehyde) sulfonate]) purchased from HUNTSMAN, and an NNO dispersant (sodium methylene bis-naphthalene sulfonate) purchased from Jiangsu Haian Petrochemical Plant.

The thickener is a waterborne polyurethane thickener with a solid content of about 20-40% and preferably about 25-35%, and the waterborne polyurethane thickener has the following structure:

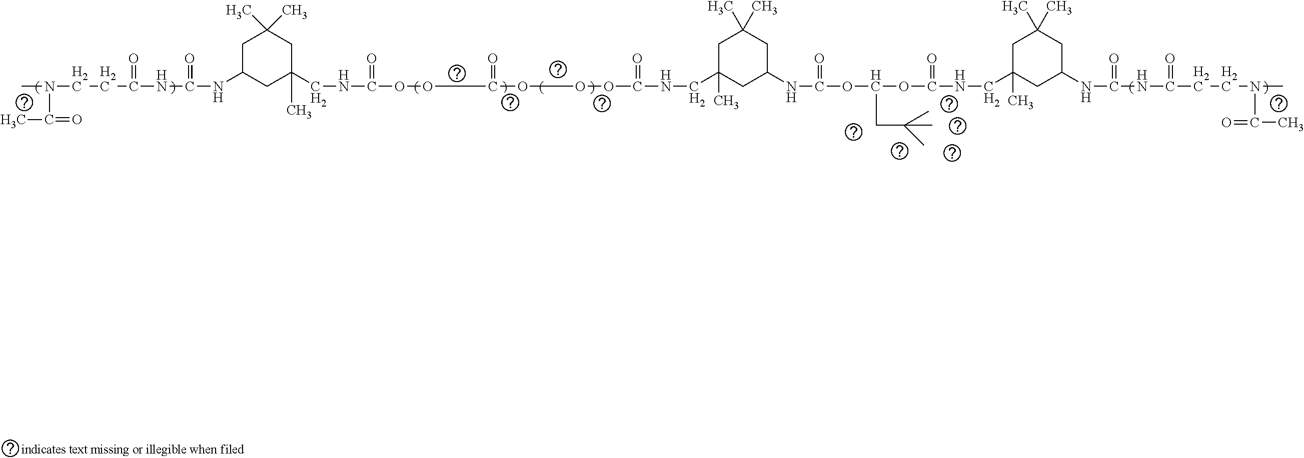

where m is 8-20, preferably 8-15, n is 15-25, preferably 17-20, and k is 1-8, preferably 2-6.

The waterborne polyurethane thickener may be prepared by, for example, a prepolymer dispersion method.

In one embodiment, a method for preparing the waterborne polyurethane thickener sequentially includes the following steps:
stirring a mixture of about 24-30 parts by weight of a dry polycaprolactone diol solid powder and about 10-15 parts by weight of a dry polyethylene glycol solid powder in a reaction vessel at a temperature of about 50-60° C. for about 15-20 minutes to obtain a uniform mixture;
adding about 10-14 parts by weight of isophorone diisocyanate into the reaction vessel, heating the system to about 80-95° C. at a stirring rate of about 250-300 rpm to carry out a heat preservation reaction for about 40-45 minutes, and then lowering the system temperature to about 75-85° C.;
adding about 1.3-1.5 parts by weight of dimethylolpropionic acid into the reaction vessel to carry out a reaction continuously for about 15-25 minutes, and then lowering the system temperature to about 45-55° C.;
adding about 0.8-1.2 parts by weight of triethylamine into the reaction vessel to carry out a reaction continuously for about 25-35 minutes to obtain a waterborne polyurethane prepolymer, and then lowering the system temperature to about 35-45° C.; and
gradually adding about 169.5-183.5 parts by weight of water into the waterborne polyurethane prepolymer while slowly increasing the stirring rate from about 250-300 rpm to about 1,400-1,600 rpm, and adding dropwise about 1.6-2.3 parts by weight of an aqueous solution of N-acetylethylenediamine with a mass concentration of about 20-30% continuously into the system to obtain a waterborne polyurethane thickener with a solid content of about 20-40%.

In one specific embodiment, a method for preparing the waterborne polyurethane thickener sequentially includes the following steps:
stirring a mixture of 27 parts by weight of a dry polycaprolactone diol solid powder and 12 parts by weight of a dry polyethylene glycol solid powder in a reaction vessel at a temperature of about 55+3° C. for 15 minutes to obtain a uniform mixture; adding 10-14 parts by weight of isophorone diisocyanate into the reaction vessel, heating the system to 88+3° C. at a stirring rate of 250-300 rpm to carry out a heat preservation reaction for 40 minutes, and then lowering the system temperature to 80° C.;
adding 1.3-1.5 parts by weight of dimethylolpropionic acid into the reaction vessel to carry out a reaction continuously for 20 minutes, and then lowering the system temperature to 50° C.;
adding 1 part by weight of triethylamine into the reaction vessel to carry out a reaction continuously for 30 minutes to obtain a waterborne polyurethane prepolymer, and then lowering the system temperature to 40±2° C.; and
gradually adding 169.5-183.5 parts by weight of water into the waterborne polyurethane prepolymer while slowly increasing the stirring rate from 250-300 rpm to 1,500 rpm, and adding dropwise 2 parts by weight of an aqueous solution of N-acetylethylenediamine with a mass concentration of 20% continuously into the system to obtain a waterborne polyurethane thickener with a solid content of 30%.

The purity grades of all the isophorone diisocyanate, the dimethylolpropionic acid, the triethylamine and the N-acetylethylenediamine mentioned above are equal to or greater than industrial purity values. The polycaprolactone diol has an average molecular weight of about 2,000-2,400 g/mol, the polyethylene glycol has an average molecular weight of about 400-1,000 g/mol, and the purity grades of all the compounds are equal to or greater than industrial purity values. All the raw materials are commercially available.

A specific reaction process of the above preparation is as follows:

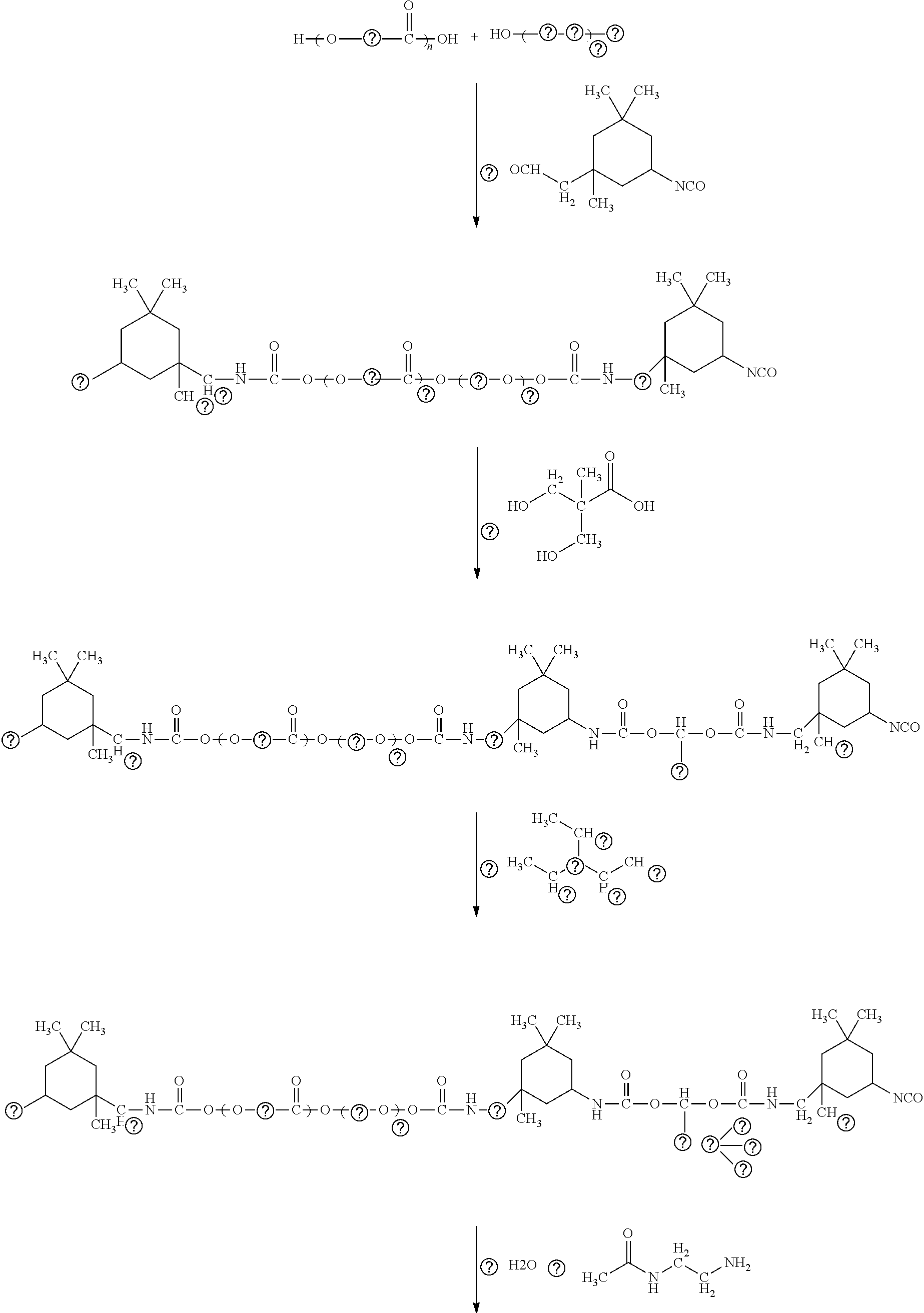

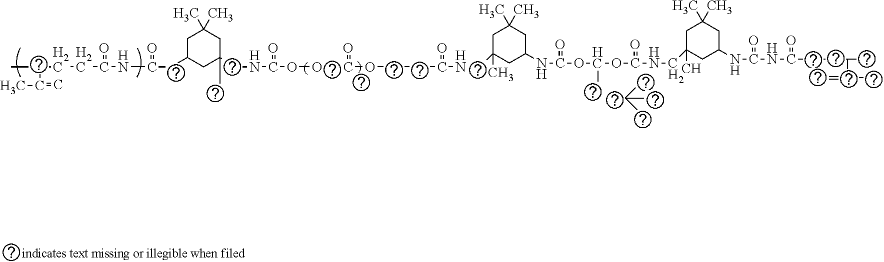

The water may be distilled water or deionized water.

A method for preparing the printing ink for the washing-free cold transfer printing process is known in the art. For example, a preparation method may include:
adding about 3.0-15.0% of the waterborne polyurethane thickener with a solid content of 20-40% into a container, adding about 40-60% of the water, and performing full stirring for about 2 hours to obtain a stock thickener paste for later use;
adding about 0.5-2.0% of the dispersant into an appropriate amount of water, performing full stirring, then adding about 1.0-10.0% of the disperse dye, about 2.0-6.0% of the binder and about 0.5-2.0% of the surfactant, and performing full stirring for dissolution to obtain a mixed paste; and
mixing the mixed paste with the stock thickener paste, adjusting the balance of the mixture to 100% with water, and performing full stirring to obtain the printing ink for the washing-free cold transfer printing process.

The viscosity of the printing ink is usually about 100-6,000 mPa·s, preferably 150-5,000 mPa·s.

In another aspect, the present disclosure provides a method for washing-free cold transfer printing on a polyester fabric, which includes using the printing ink described above.

The method does not require the step of washing for color fixing.

The polyester fabric may be polyester fabrics known in the art that can be printed and dyed with disperse dyes, including, for example, a lotaf fabric, a taffeta fabric, a polyester plain weave fabric, a polyester habotai fabric, a polyester oxford fabric, a sanded polyester blended fabric and the like.

A method of using the printing ink in cold transfer printing is known in the art. For example, by way of intaglio, flexographic or rotary screen printing, a pattern of the printing ink is printed on a transfer carrier to make a stained paper. The transfer carrier is known in the art, including, for example, a printing film, a printing paper, a transfer blanket or a transfer roller. Then, a polyester fabric and the transfer carrier are superimposed and subjected to pressure transfer printing so as to transfer the pattern to the polyester fabric. Then, the transferred polyester fabric is subjected to treatment by a color fixing step. For example, the color fixing step is performed by a high temperature and high pressure steaming or baking process known in the art. The high temperature and high pressure steaming is usually performed at a high temperature of about 125-135° C. and a saturated vapor pressure (2.3-3.1 MPa) for about 20-40 minutes, and the baking process is usually performed at a temperature of about 180-220° C. for 30-90 s.

The method for washing-free cold transfer printing in the present disclosure does not require the step of washing for color fixing, thereby avoiding the production of printing wastewater and reducing printing wastewater or even realizing zero discharge of wastewater, which has huge economic and social benefits.

Moreover, even when the method for cold transfer printing in the present disclosure eliminates the step of washing for color fixing, a finished printed product obtained has color fastness to laundering which can still reach grade 4 or above, wet rubbing fastness reach grade 4, and dry rubbing fastness reach grade 4-5. The color fastness to laundering is tested by a method based on the standard of GB/T 5713-2013 or AATCC 61-2013, and the wet rubbing fastness and the dry rubbing fastness are tested by a method based on the standard of GB/T 3920-1997 or AATCC 8-2016.

In another aspect, the present disclosure provides a thickener of a printing ink for a washing-free cold transfer printing process. The thickener is a waterborne polyurethane thickener with a solid content of about 20-40% and preferably about 25-35%, and the waterborne polyurethane thickener has the following structure:

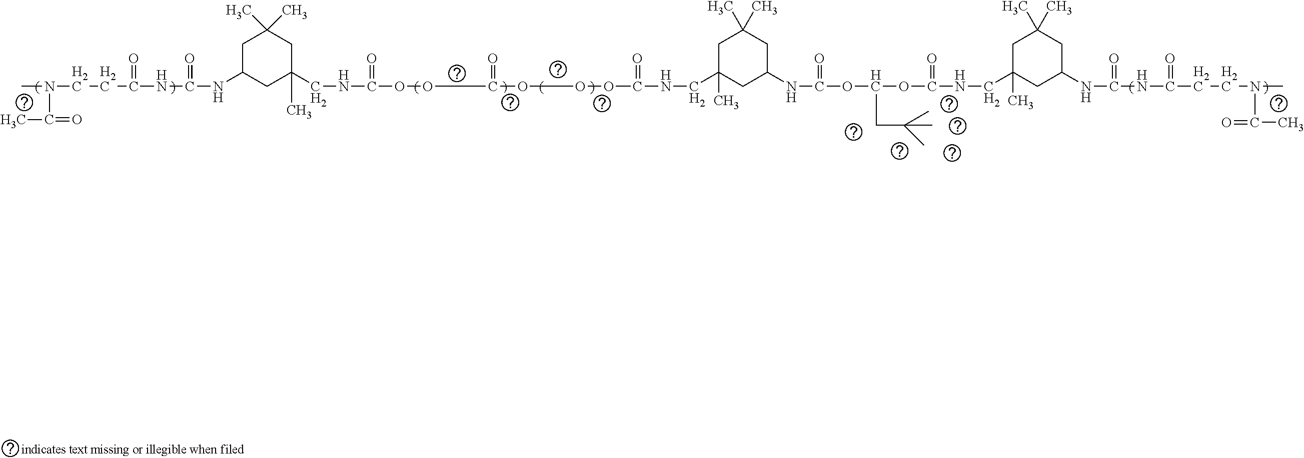

where m is 8-20, preferably 8-15, n is 15-25, preferably 17-20, and k is 1-8, preferably 2-6.

The waterborne polyurethane thickener is prepared by the above method. The waterborne polyurethane thickener is a novel waterborne polyurethane thickener obtained by prepolymer chain extension modification of a polyurethane body. The waterborne polyurethane thickener does not contain halogen, a sulfonic acid group and other color-changing groups, ensuring the controllability of the color of the disperse dye. In addition, the thickener has excellent thermal stability, adhesion and storage stability, which is very suitable for the washing-free printing ink containing the disperse dye of the present disclosure. By way of the waterborne polyurethane thickener, adsorption of the disperse dye by a polyester fiber is enhanced when the disperse dye is in contact with the polyester fiber in transfer printing. Then dye molecules of an adsorption layer are diffused into the fiber through free volume for dyeing under the action of pressure transfer printing and chemical potential. The dye carried by a synthetic paste continues to supplement and be adsorbed onto the surface of the fiber, and the whole system maintains a dynamic balance, so that the dyeing effect and color fastness of the dye are obviously improved. Finally, a washing process for removing the unfixed dye and fixing color are not required in the cold transfer printing process.

### BRIEF DESCRIPTION OF THE DRAWINGS

FIG. 1 shows an infrared spectrogram of a waterborne polyurethane thickener used in Example 1.

### DETAILED DESCRIPTION

### Examples

The present disclosure is further illustrated through non-restrictive examples, and it is to be noted that these examples should not be regarded as limitations of the present invention.

### Example 1

In this example, with a printing paper as a transfer carrier, a pattern of a dark printing ink for a washing-free cold transfer printing process was transferred to a polyester taffeta textile by intaglio printing.

A formula of the dark printing ink included:

| | |
|---|---|
| disperse dye | 10.0%; |
| waterborne polyurethane thickener | 5.0%; |
| with a solid content of 30% | |
| binder | 6.0%; |
| surfactant | 1.0%; |
| dispersant | 2.0%; |
| distilled water | added to 100%. |

The disperse dye was a medium temperature SE type disperse dye purchased from HUNTSMAN. The binder was a TF-320 binder purchased from Zhejiang Transfar Co., Ltd. The surfactant was BYK-378 purchased from BYK Chemical. The dispersant was INVALONDAM purchased from HUNTSMAN. The waterborne polyurethane was:

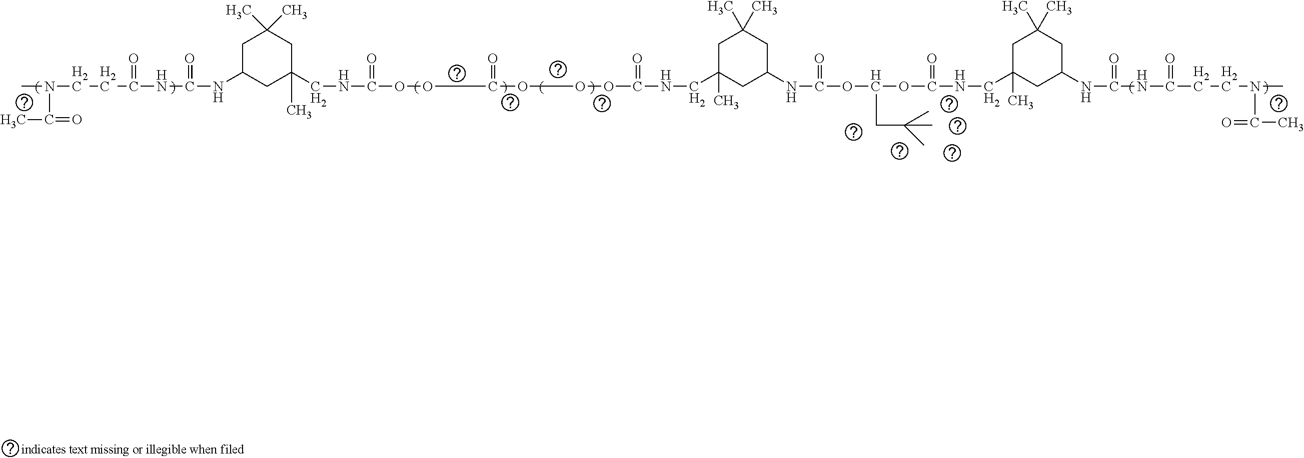

where m is 8, n is 17, and k is 4.

Preparation of the waterborne polyurethane included:
stirring a mixture of 27 parts by weight of a dry polycaprolactone diol (average molecular weight: 2,000 g/mol) solid powder and 12 parts by weight of a dry polyethylene glycol (average molecular weight: 400 g/mol) solid powder in a reaction vessel at a temperature of 55+3° C. for 15 minutes to obtain a uniform mixture;
adding 10 parts by weight of isophorone diisocyanate into the reaction vessel, heating the system to 88+3° C. at a stirring rate of 250 rpm to carry out a heat preservation reaction for 40 minutes, and then lowering the system temperature to 80° C.;
adding 1.3 parts by weight of dimethylolpropionic acid into the reaction vessel to carry out a reaction continuously for 20 minutes, and then lowering the system temperature to 50° C.; adding 1 part by weight of triethylamine into the reaction vessel to carry out a reaction continuously for 30 minutes to obtain a waterborne polyurethane prepolymer, and then lowering the system temperature to 40° C.; and
gradually adding 183.5 parts by weight of deionized water into the waterborne polyurethane prepolymer while slowly increasing the stirring rate from 250 rpm to 1,500 rpm, and adding dropwise 2 parts by weight of an aqueous solution of N-acetylethylenediamine with a mass concentration of 20% continuously into the system to obtain a waterborne polyurethane thickener with a solid content of 30%.

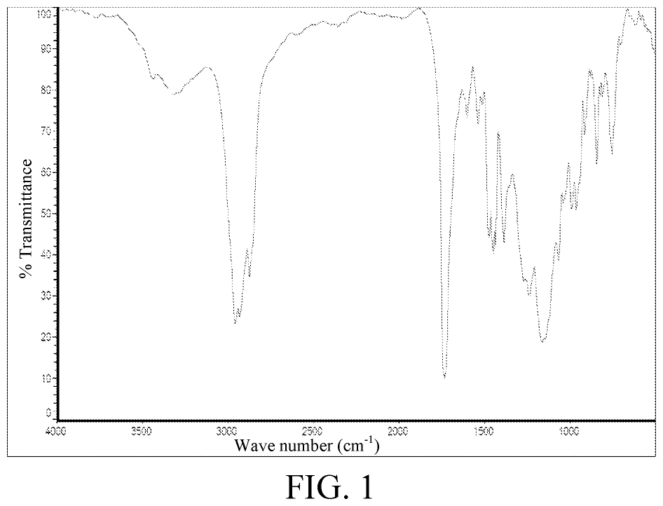

An infrared spectrogram of the obtained waterborne polyurethane thickener is shown in FIG. 1.

### Preparation of the Printing Ink Included:

adding 5% of the waterborne polyurethane thickener with a solid content of 30% into a container, adding 50% of the distilled water, and performing full stirring for 2 hours for dissolution to obtain a stock thickener paste;
adding 2.0% of the dispersant into an appropriate amount of distilled water, performing full stirring, then adding 10.0% of the disperse dye, 6.0% of the binder and 1.0% of the surfactant, and performing full stirring for dissolution to obtain a mixed paste; and
mixing the mixed paste with the stock thickener paste, adjusting a mixture to 100% with water, and performing full stirring to obtain the printing ink with a viscosity of 800 mPa·s.

By way of the intaglio printing, the pattern of the printing ink was printed on the transfer printing paper, the polyester taffeta textile (specification: 63Dx63D/160T) and the transfer printing paper were superimposed and subjected to pressure transfer printing so as to transfer the pattern to the textile. Then, the transferred textile was subjected to high temperature and high pressure steaming for color fixing at a temperature of 125° C. and a saturated vapor pressure of 2.3 MPa for 35 minutes to obtain a finished printed product.

The color fastness to laundering, wet rubbing fastness and dry rubbing fastness of the finished printed product were tested by methods based on the standards of AATCC 61-2013 and AATCC 8-2016.

Results show that the finished printed product obtained has color fastness to laundering at grade 4 or above, wet rubbing fastness at grade 4 and dry rubbing fastness at grade 4-5.

### Example 2

In this example, with a transfer printing film as a transfer carrier, a pattern of a light printing ink for a washing-free cold transfer printing process was transferred to a polyester oxford fabric by flexographic printing.

A formula of the light printing ink included:

| | |
|---|---|
| disperse dye | 2.0%; |
| waterborne polyurethane thickener | 3.0%; |
| with a solid content of 30% | |
| binder | 2.0%; |
| surfactant | 0.5%; |
| dispersant | 0.5%; |
| distilled water | added to 100%. |

The disperse dye was a high temperature S type disperse dye purchased from Zhejiang Longsheng Group Co., Ltd. The binder was a 9122 binder purchased from Hangzhou Yinsheng Chemical Factory. The surfactant was SF-678 purchased from Shanmu Chemical Co., Ltd. The dispersant was an INVALONDAM dispersant purchased from HUNTSMAN. The waterborne polyurethane was:

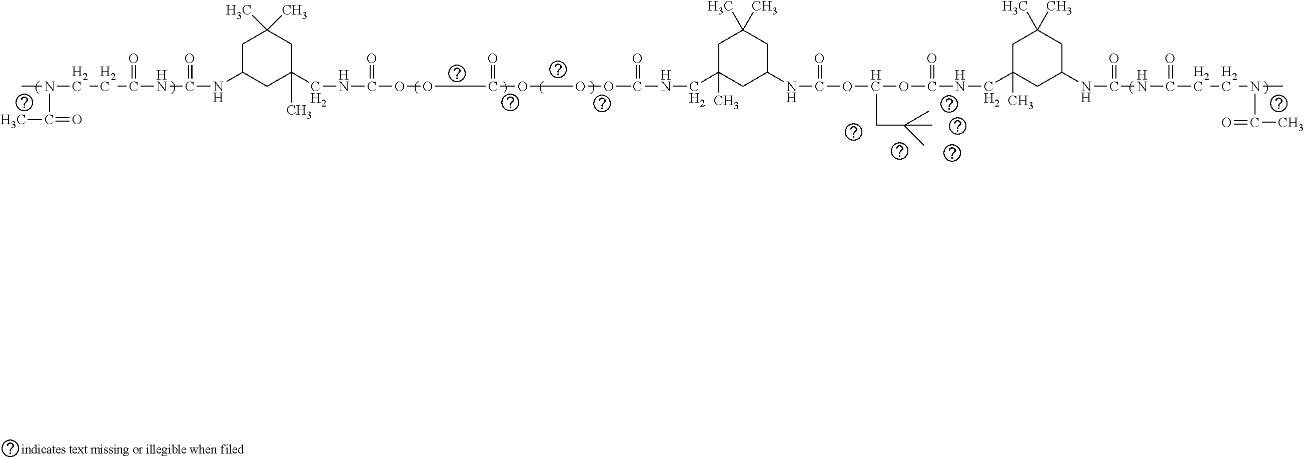

where m is 13, n is 18, and k is 2.

### Preparation of the Waterborne Polyurethane Included:

stirring a mixture of 27 parts by weight of a dry polycaprolactone diol (average molecular weight: 2,000 g/mol) solid powder and 12 parts by weight of a dry polyethylene glycol (average molecular weight: 1,000 g/mol) solid powder in a reaction vessel at a temperature of 55+3° C. for 15 minutes to obtain a uniform mixture;
adding 14 parts by weight of isophorone diisocyanate into the reaction vessel, heating the system to 88-3° C. at a stirring rate of 250 rpm to carry out a heat preservation reaction for 40 minutes, and then lowering the system temperature to 80° C.;
adding 1.5 parts by weight of dimethylolpropionic acid into the reaction vessel to carry out a reaction continuously for 20 minutes, and then lowering the system temperature to 50° C.;
adding 1 part by weight of triethylamine into the reaction vessel to carry out a reaction continuously for 30 minutes to obtain a waterborne polyurethane prepolymer, and then lowering the system temperature to 40±2° C.; and
gradually adding 169.5 parts by weight of deionized water into the waterborne polyurethane prepolymer while slowly increasing the stirring rate from 250 rpm to 1,500 rpm, and adding dropwise 2 parts by weight of an aqueous solution of N-acetylethylenediamine with a mass concentration of 20% continuously into the system to obtain a waterborne polyurethane thickener with a solid content of 30%.

Preparation of the printing ink included:
adding 3% of the waterborne polyurethane thickener with a solid content of 30% into a container, adding 50% of the distilled water, and performing full stirring for 2 hours for dissolution to obtain a stock thickener paste;
adding 0.5% of the dispersant into an appropriate amount of distilled water, performing full stirring, then adding 2.0% of the disperse dye, 2.0% of the binder and 0.5% of the surfactant, and performing full stirring for dissolution to obtain a mixed paste; and
mixing the mixed paste with the stock thickener paste, adjusting a mixture to 100% with water, and performing full stirring to obtain the printing ink for the washing-free cold transfer printing process with a viscosity of 150 mPa·s.

By way of the flexographic printing, the pattern of the printing ink was printed on the transfer printing film, the polyester oxford fabric (specification: 300Dx600D/90T) and the transfer printing film were superimposed and subjected to pressure transfer printing so as to transfer the pattern to the textile. Then, the transferred textile was subjected to baking for color fixing at a temperature of 200° C. for about 60 s to obtain a finished printed product.

The color fastness to laundering, wet rubbing fastness and dry rubbing fastness of the finished printed product were tested by the experimental methods in Example 1.

Results show that the finished printed product obtained has color fastness to laundering at grade 4 or above, wet rubbing fastness at grade 4 and dry rubbing fastness at grade 4-5.

### Example 3

In this example, with a transfer roller as a transfer carrier, a pattern of a medium dark printing ink for a washing-free cold transfer printing process was transferred to a sanded polyester blended fabric by rotary screen transfer printing equipment.

A formula of the medium dark printing ink included:

| | |
|---|---|
| disperse dye | 6.0%; |
| waterborne polyurethane thickener | 15.0%; |
| with a solid content of 30% | |
| binder | 5.0%; |
| surfactant | 1.5%; |
| dispersant | 1.0%; |
| deionized water | added to 100%. |

The disperse dye was a medium temperature SE type disperse dye purchased from Zhejiang Runtuo Co., Ltd. The binder was a TF-320 binder purchased from Zhejiang Transfar Co., Ltd. The surfactant was BYK-378 purchased from BYK Chemical. The dispersant was an NNO dispersant purchased from Jiangsu Haian Petrochemical Plant. The waterborne polyurethane was:

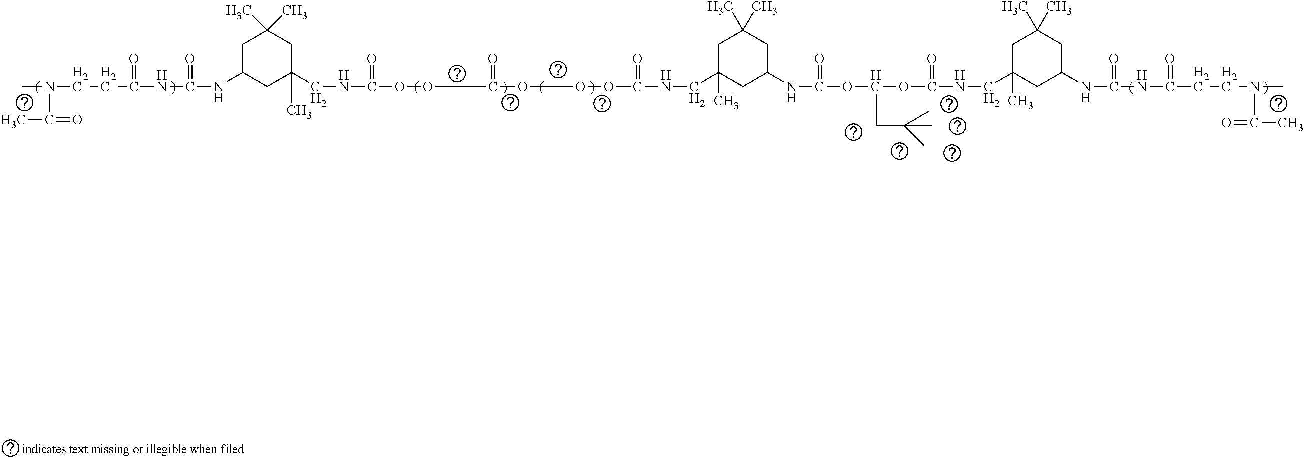

where m is 18, n is 22, and k is 6.

Preparation of the waterborne polyurethane included:
stirring a mixture of 27 parts by weight of a dry polycaprolactone diol (average molecular weight: 2,400 g/mol) solid powder and 12 parts by weight of a dry polyethylene glycol (average molecular weight: 400 g/mol) solid powder in a reaction vessel at a temperature of 55+3° C. for 15 minutes to obtain a uniform mixture;
adding 12 parts by weight of isophorone diisocyanate into the reaction vessel, heating the system to 88+3° C. at a stirring rate of 300 rpm to carry out a heat preservation reaction for 40 minutes, and then lowering the system temperature to 80° C.;
adding 1.5 parts by weight of dimethylolpropionic acid into the reaction vessel to carry out a reaction continuously for 20 minutes, and then lowering the system temperature to 50° C.;
adding 1 part by weight of triethylamine into the reaction vessel to carry out a reaction continuously for 30 minutes to obtain a waterborne polyurethane prepolymer, and then lowering the system temperature to 40±2° C.; and
gradually adding 177 parts by weight of deionized water into the prepolymer while slowly increasing the stirring rate from 300 rpm to 1,500 rpm, and adding dropwise 2 parts by weight of an aqueous solution of N-acetylethylenediamine with a mass concentration of 20% continuously into the system to obtain a waterborne polyurethane thickener with a solid content of 30%.

Preparation of the printing ink included:
adding 15% of the waterborne polyurethane thickener with a solid content of 30% into a container, adding 50% of the deionized water, and performing full stirring for 2 hours for dissolution to obtain a stock thickener paste;
adding 1.0% of the dispersant into an appropriate amount of distilled water, performing full stirring, then adding 6.0% of the disperse dye, 5.0% of the binder and 1.5% of the surfactant, and performing full stirring for dissolution to obtain a mixed paste; and
mixing the mixed paste with the stock thickener paste, adjusting a mixture to 100% with water, and performing full stirring to obtain the printing ink for the washing-free cold transfer printing process with a viscosity of 6,000 mPa·s.

By way of the rotary screen transfer printing equipment, the pattern of the printing ink was printed on the transfer roller, the transfer roller and the sanded polyester blended fabric (specification: 75Dx150D/150T) were superimposed and subjected to pressure transfer printing so as to transfer the pattern to the textile. Then, the transferred textile was subjected to high temperature and high pressure steaming for color fixing at a temperature of 130° C. and a saturated vapor pressure of 2.7 MPa for about 20 minutes to obtain a finished printed product.

The color fastness to laundering, wet rubbing fastness and dry rubbing fastness of the finished printed product were tested by the experimental methods in Example 1.

Results show that the finished printed product obtained has color fastness to laundering at grade 4 or above, wet rubbing fastness at grade 4 and dry rubbing fastness at grade 4-5.

1. A printing ink for a washing-free cold transfer printing process, wherein the printing ink comprises a thickener, a disperse dye, a binder, a surfactant, a dispersant and water,
wherein the thickener is a waterborne polyurethane thickener with a solid content of 20-40%, and the waterborne polyurethane thickener has the following structure: 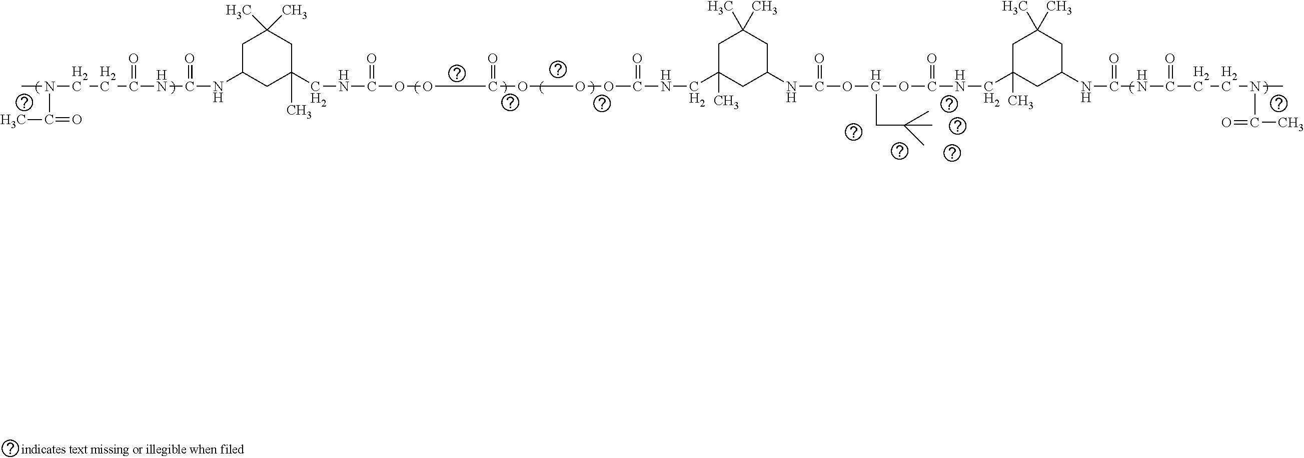
wherein m is 8-20, n is 15-25, and k is 1-8.

2. The printing ink according to claim 1, wherein the thickener is a waterborne polyurethane thickener with a solid content of 25-35%.

3. The printing ink according to claim 1, wherein m is 8-15, n is 17-20, and k is 2-6.

4. The printing ink according to claim 1, wherein the printing ink comprises 3.0-15.0% of the thickener.

5. The printing ink according to claim 4, wherein the printing ink comprises 5.0-10.0% of the thickener.

6. The printing ink according to claim 1, wherein the printing ink comprises 3.0-15.0% of the thickener, 1.0-10.0% of the disperse dye, 2.0-6.0% of the binder, 0.5-2.0% of the surfactant, 0.5-2.0% of the dispersant and the balance of water, based on the total weight of the printing ink.

7. A method for washing-free cold transfer printing on a polyester fabric, wherein the method comprises using the printing ink according to claim 1, wherein the method does not have a step of washing for color fixing.

8. The method according to claim 7, wherein the polyester fabric is selected from a lotaf fabric, a taffeta fabric, a polyester plain weave fabric, a polyester habotai fabric, a polyester oxford fabric, and a sanded polyester blended fabric.

9. A thickener of a printing ink for a washing-free cold transfer printing process, wherein the thickener is a waterborne polyurethane thickener with a solid content of 20-40%, and the waterborne polyurethane thickener has the following structure: 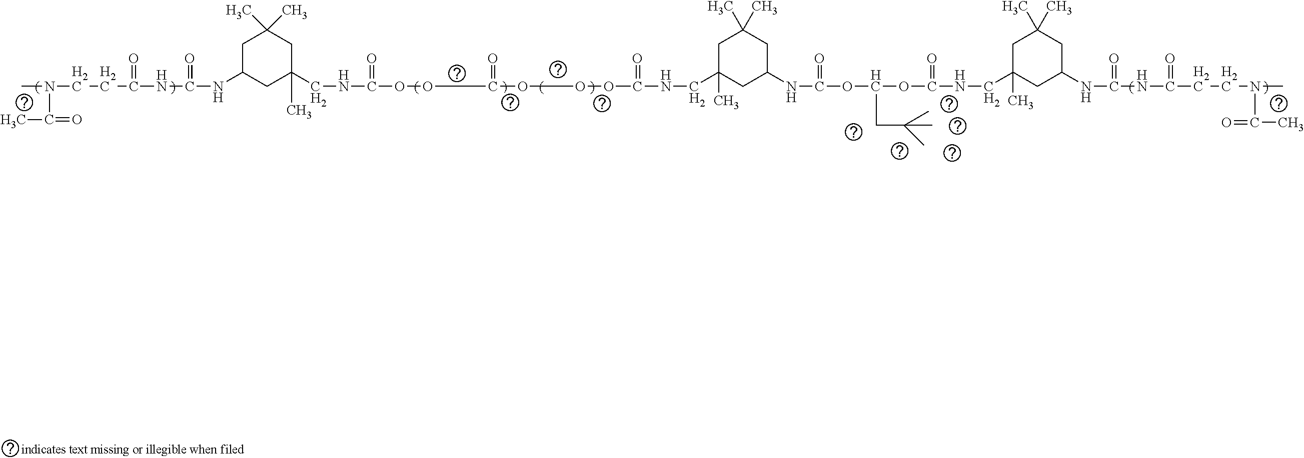
wherein m is 8-20, n is 15-25, and k is 1-8.

10. A method for preparing a thickener having the following structure: 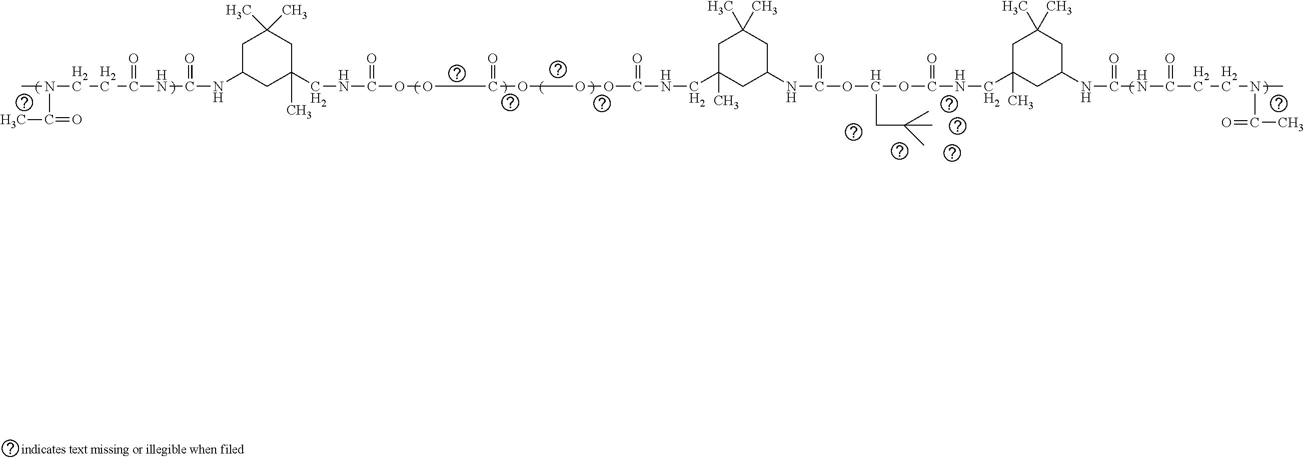
wherein m is 8-20, n is 15-25, and k is 1-8, and the method comprises:
stirring a mixture of 24-30 parts by weight of a dry polycaprolactone diol solid powder and 10-15 parts by weight of a dry polyethylene glycol solid powder in a reaction vessel at a temperature of 50-60° C. for 15-20 minutes to obtain a uniform mixture;
adding 10-14 parts by weight of isophorone diisocyanate into the reaction vessel, heating the system to 80-95° C. at a stirring rate of 250-300 rpm to carry out a heat preservation reaction for 40-45 minutes, and then lowering the system temperature to 75-85° C.;
adding 1.3-1.5 parts by weight of dimethylolpropionic acid into the reaction vessel to carry out a reaction continuously for 15-25 minutes, and then lowering the system temperature to 45-55° C.;
adding 0.8-1.2 parts by weight of triethylamine into the reaction vessel to carry out a reaction continuously for 25-35 minutes to obtain a waterborne polyurethane prepolymer, and then lowering the system temperature to 35-45° C.; and
gradually adding 169.5-183.5 parts by weight of water into the waterborne polyurethane prepolymer while slowly increasing the stirring rate from 250-300 rpm to 1,400-1,600 rpm, and adding dropwise 1.6-2.3 parts by weight of an aqueous solution of N-acetylethylenediamine with a mass concentration of 20-30% continuously into the system to obtain the thickener.
